(19) United States
(12) Patent Application Publication
(10) Pub. No.: US 2024/0369403 A1
(43) Pub. Date: Nov. 7, 2024

(54) METHOD FOR RESONANCE ANALYSIS OF A VIBRATION MACHINE

(71) Applicant: Sandvik Rock Processing Australia PTY Limited, North Ryde, New South Wales (AU)

(72) Inventor: Jan SCHÄFER, Darmstadt (DE)

(73) Assignee: Sandvik Rock Processing Australia PTY Limited, North Ryde, New South Wales (AU)

(21) Appl. No.: 18/681,659

(22) PCT Filed: Jul. 7, 2022
(86) PCT No.: PCT/EP2022/068821

§ 371 Date: Feb. 6, 2024

(30) Foreign Application Priority Data
Aug. 6, 2021 (DE) 10 2021 120 494.1

(51) Int. Cl. G01H 13/00; G01M 13/00

(52) U.S. Cl. CPC G01H 13/00; G01M 13/00

(57) ABSTRACT

A method for resonance analysis of a vibrating machine, in particular a vibrating screen or a vibrating conveyor, including the following steps during operation:—determining an operational vibration signal, which includes the vibrations of the machine in regular operation,—exciting the vibrating machine during operation by an excitation signal for exciting additional vibrations on the vibrating machine,—measuring a response vibration signal of the vibrating machine in response to the excitation,—determining a subtraction signal by using the operational vibration signal as a correction signal which is subtracted from the response vibration signal, and—carrying out frequency analysis of the subtraction signal, the dominant frequencies of the subtraction signal corresponding to the natural frequencies of the system in the frequency range of the excitation signal.

### FIELD

The present invention relates to a method for resonance analysis of a vibration machine.

### BACKGROUND

Machines that have a vibration unit can be damaged by the self-generated vibration if the vibration of the vibration unit is the same or similar to the natural frequency of the machine. Due to the periodically recurring excitation, more and more energy is transferred to the system. Due to this constructive interference, the energy is stored in the system until a resonance catastrophe occurs. In the worst case, this can destroy the machine.

To avoid this, it is necessary to know the frequency at which such a resonance catastrophe can occur. This is done with so-called resonance analyses.

Until now, resonance analyses have involved causing the machine to vibrate with a short external impulse, e.g. by hitting the machine with an impulse hammer. Meanwhile, sensors record the vibration response to the single impulse. The impulse is a Dirac signal, i.e. a short-term signal that is superimposed by a large number of oscillations. Using appropriate analysis methods, such as a frequency analysis of the measurement, conclusions can be drawn about the natural frequency of the machine.

To carry out this vibration analysis, the vibration machine is stopped so that the vibration response is not superimposed with other vibration signals.

DE 10 2005 042085 A1 discloses a vibration measurement system for frequency-selective vibration measurement, in particular of low frequencies as are relevant in the field of automation and drive technology. It is proposed to couple a broadband transmitter structure, which is directly excited by the excitation signal to be determined, to a receiver structure via an electrostatic or inductive force. This force coupling results in amplitude modulation of a carrier signal that excites the receiver structure. The actual excitation signal can be extracted from the spectrum of the amplitude-modulated carrier signal, e.g. by selecting a suitable frequency for the carrier signal. In order to enable a vibration analysis that is as immune to interference as possible, an interference signal caused by nozzle excitation, for example, is largely eliminated from the amplitude-modulated carrier signal beforehand.

WO 2004/059399 A2 discloses a system for diagnosing or testing the condition of machines and their parts, in particular rotating machines and their components, such as aircraft and helicopter engines, gearboxes, etc., on the basis of vibration data. During operation, vibrations are measured at various points on the machine using sensors and a so-called “vibration signature” is created. In the case of aircraft engines, for example, different rotational speeds and other parameters are also taken into account. For the “normal case”, i.e. the intact condition of the machine, a so-called “baseline signature” is created. Deviations of the vibration signature data from the baseline signature during subsequent measurements can provide indications of irregularities, such as wear or damage to rotating parts, clogged nozzles, etc., and of possible failure risks.

Rahman et al, “Effectiveness of Impact-Synchronous Time Averaging in determination of dynamic characteristics of a rotor dynamic system”, Measurement 44, (2011), 34-45, discloses a method in which a spectrum of the vibrations of a rotating system are recorded. Natural frequencies of the rotating system are also to be characterized. One problem addressed by Rahman et al. is background and harmonics caused by the rotational forces, which can dominate the spectrum and mask the natural frequencies. In contrast to non-rotating systems, such as a vibrating machine, the dynamic properties and thus the determined spectrum of the rotating systems addressed by Rahman et al. are also influenced by gyroscopic effects that depend on the rotational speed. A method presented by Rahmean et al., ISTA (Impact-Synchronous Time Averaging), should be suitable for eliminating the components dependent on the rotational speed, their harmonics and the background from the determined response signal.

WO 2019/072462 A1 discloses a mobile device for detecting the status and operating parameters of vibrating machines with sensor units and an evaluation unit connected to the sensor units, wherein the measurement data detected by the sensor units can be transmitted wirelessly to the evaluation unit, and wherein each sensor unit is equipped with at least three orthogonally aligned acceleration sensors and an integrated circuit for processing the measurement data detected by the sensor units. At least four sensor units form a sensor network, wherein the sensor units can be detachably attached to the vibrating machine at a mutual distance with an undefined orientation, and a local coordinate system X1, Y1, Z1 is defined by the at least three acceleration sensors of a sensor unit, to the spatial axes of which the local measurement data recorded in a sensor unit are related, and each sensor unit has a gravity sensor for detecting the orientation of the local coordinate system X1, Y1, Z1 in space, and the evaluation unit has a device for transforming the local measurement data into a higher-level uniform coordinate system X0, Y0, Z0, taking into account the measurement data of the gravity sensor.

### SUMMARY

The object of the present invention is to perform a resonance analysis of a vibration machine that is simple and inexpensive and disrupts operation as little as possible.

The task is solved by the subject-matter of the independent claims. Advantageous further developments and preferred embodiments form the subject-matter of the sub-claims.

A method for resonance analysis of a vibration machine, in particular a vibrating screen or a vibrating conveyor, during operation comprises the following steps:
determination of an operating vibration signal comprising the vibrations of the vibration machine in regular operation,
excitation of the vibration machine during operation with an excitation signal for exciting additional vibrations at the vibration machine, wherein the excitation signal is a Dirac pulse,
measuring a response vibration signal of the vibration machine to the excitation during operation,
determining a correction signal (9) by using the operating vibration signal (8),
determining a subtraction signal by subtracting the correction signal from the response vibration signal, and
frequency analysis of the subtraction signal for determining the natural frequencies of the vibration machine, wherein the dominant frequencies of the subtraction signal correspond to the natural frequencies of the system in the frequency range of the excitation signal.

A vibration machine is a machine that is intentionally set into vibration, at least in part, during operation, whereby this vibration oscillates at a predetermined frequency.

The vibration machine has at least one natural frequency, which is characterized by the fact that if the frequency of the operating vibration is equal to the natural frequency, it can lead to a resonance catastrophe.

The operating vibration signal and the response vibration signal are measured by a vibration detection device, whereby the vibration detection device comprises at least one or more vibration sensors. These vibration sensors can be, for example, MEMS acceleration sensors, piezo sensors or sensors from microphone technology. Sensors from microphone technology are, for example, pressure microphones, condenser microphones, moving coil microphones, ribbon microphones or crystal microphones.

The determination of the subtraction signal as well as the frequency analysis of the subtraction signal is carried out on a computer, whereby computer is to be understood here generally and can include PCs, laptops, portable handheld devices such as smartphones and tablets, but also devices specially manufactured for this method.

The vibration machine can be excited manually or mechanically. Excitation using an impulse hammer is common.

Up to now, it was not possible to carry out a resonance analysis during operation, as the operating oscillations dominate any measurement and superimpose impulse responses of an excitation signal, so that only the frequency of the operating oscillation could be recognized in the evaluation, e.g. after a Fourier transformation of the signal. It was not possible to determine the vibration response here.

The inventors have recognized that the operating oscillations remain stable over time. In this context, stable over time means that the frequencies, amplitudes and phases of the operating oscillation do not change by more than 10%, preferably not more than 5% and in particular not more than 1% within, for example, 10 minutes.

The operating vibration also depends on the load condition of the vibration machine. An unloaded vibration machine shows essentially the same operating vibration over a long period of time, e.g. several weeks. If the load condition changes, the vibration behavior of the vibration machine can change. The vibration amplitude can change by up to 10%. It is therefore advisable to record the operating vibration signal and the response vibration signal in essentially the same load condition.

As the operating oscillation is stable over time, the operating vibration signal can be used as a correction signal and subtracted from the measurement signal, e.g. the response vibration signal. The response vibration signal generated by the excitation signal remains as the signal.

If no excitation signal was transmitted to the oscillating machine, a zero line results as a subtraction signal after deduction of the correction signal.

One advantage of this method is that it can be carried out during operation. In contrast to the prior art, a user does not have to shut down the machine to be analyzed and can continue to use it during the measurement. The resonance analysis of the machine can also be carried out during regular operation, i.e. when the machine is loaded. Depending on the area of application of such a vibration machine, the costs incurred by downtime during a measurement can amount to several million euros. Many users therefore shy away from such a check and risk damaging the machine. In the worst case, this can endanger human life.

Depending on the application location, other machines that are in close proximity to the vibration machine and which themselves operate at a certain frequency can also cause the vibration machine to vibrate. Previously, these machines would also have had to be brought to a standstill, as otherwise the measurement would have been “contaminated”. This means that the frequencies of the other machines would also appear in the analysis, which could result in incorrect natural frequencies being determined for the vibration machine under investigation. To rule this out, entire factory halls and production facilities have sometimes been shut down to test a single machine. This is uneconomical.

In the present method, however, the vibration of surrounding machines can also be included in the correction signal as part of the operating vibration signal and then subtracted from the response vibration signal. The only requirement here is that the properties of the surrounding machines do not change, e.g. when they are switched on or off or a different frequency is set.

Another advantage is that the natural frequency of the machine is measured under realistic conditions. The inventors have recognized that when the machine is at a standstill, the natural frequencies differ slightly from the natural frequencies during operation. This is due, for example, to the fact that the corresponding machine is filled and the filling material has an effect on the natural frequencies.

Since the vibration behavior can change due to a load, the resonance analysis during regular operation is more realistic than conventional resonance analyses, in which the vibration machine is analyzed in an unloaded state and out of operation. Preferably, the operating vibration signal is modified before it is used as a correction signal. For this purpose, the correction signal can be modeled on the operating vibration signal, for example as a function, e.g. by means of fitting.

When generating the correction signal, the frequency with the highest amplitude can be determined from the operating vibration signal, which is referred to below as the operating frequency. The amplitude and phase of the operating frequency in the operating vibration signal and the amplitude and phase of the harmonics of the operating frequencies in the operating vibration signal are then determined. The correction signal is then generated from the amplitude and phase of the operating frequency and from the amplitude and phase of the harmonics of the operating frequency.

However, the correction signal can also include signals from other machines in operation in the vicinity and/or around sidebands and/or spring/hard body resonances of the vibration machine.

The operating vibration signal essentially corresponds to a sinusoidal oscillation, whereby the sinusoidal oscillation is superimposed on the sinusoidal oscillations of the harmonics. It is therefore useful if the correction signal is also represented as a sinusoidal signal of the operating frequency, which is superimposed on the sinusoidal signals of the harmonics. A sine function can be defined by the frequency f, amplitude A and phase P. If the frequency, amplitude and phase of the operating frequency and the harmonics are known, this information can be used to generate the correction signal.

Preferably, the harmonics are one or more of the multiples of the operating frequency, preferably they are ½, 3/2, ¼, 2, 3, 4, 5, 8, 16 and 32 times the operating frequency.

A multiple of the operating frequency can also be a fraction of the natural frequency, e.g. ½ or ¼. These are then called subharmonics.

In the simplest case, the operating vibration signal can be shown graphically on a display and the parameters of the correction signal are adjusted so that it corresponds as closely as possible to the operating vibration signal. Alternatively, the subtraction signal can also be generated continuously by subtracting the correction signal from a response vibration signal, which is measured continuously, without an excitation oscillation being applied to the oscillating machine. The parameters of the correction signal are then adjusted until a zero line can be recognized as the response vibration signal.

Preferably, the operating vibration signal is estimated by automatic parameter estimation and modified with the resulting parameters.

Methods for automatic parameter estimation, also known as fit, are well known. Such methods are particularly suitable if the signal to be analyzed is a periodic, sinusoidal signal. Such automatic parameter estimation can be realized with a software product in which the correction signal generated in this way comes very close, in the mathematical sense, to the operating vibration signal. This allows the operating vibration signal to be almost completely subtracted from the response vibration signal, resulting only in the response of the vibration machine to the excitation signal.

Preferably, the function of the operating vibration signal is approximately given by:

$$y ( t ) = {\sum }_{n = 1}^{k} {A}_{n} sin ( nft + {P}_{n} ) ,$$

where n is the degree of the harmonic, k is the highest harmonic, Aₙ is the amplitude of the harmonic, f is the operating frequency, t is the time and Pₙ is the phase of the respective harmonic.

This mathematical function represents a sum of several sine functions.

Preferably, k is at least 1, 2 or 4 in order to obtain sufficient precision of the correction signal.

Preferably, k is a maximum of 64, 32 or 16, so that the computing effort is not too great.

If there are proportional harmonics, which are also called subharmonics, such as ½, or ¼, then the above formula is adjusted accordingly with a term for these proportional harmonics.

It is also conceivable to add other terms that have different frequencies to cover other machines in operation and/or to cover sidebands and/or spring/hard-body resonances.

Alternatively, the correction signal can also be modeled on the operating vibration signal by recording the operating vibration signal over a predetermined duration and using it as the correction signal.

This saves the mathematical description of the operating vibration signal and uses the original operating vibration signal. The disadvantage of this could be that the required duration must be estimated. On the other hand, if the recording is too short, the recorded signal could be used repeatedly.

By using the recorded signal, the operating vibration signal can be subtracted from the response vibration signal without any loss of quality due to mathematical adjustment.

Furthermore, thereby, non-sinusoidal signals would be taken into account.

The excitation signal is a Dirac pulse.

A Dirac impulse in the sense of the present invention is to be understood as an only approximate mathematical Dirac impulse, since it is physically impossible to generate a pure mathematical Dirac impulse.

In practice, such a Dirac pulse is generated by a stroke from an impulse hammer.

A Dirac pulse is characterized by the fact that a pulse with the shortest possible duration is transmitted to the oscillating machine under investigation, whereby all frequencies are excited equally.

Frequencies that do not correspond to the natural frequency or a multiple thereof are attenuated immediately.

However, the natural frequencies and multiples thereof continue to oscillate under the influence of the Dirac impulse and can be measured.

In practice, however, such a Dirac pulse will only excite a certain spectrum of frequencies.

Preferably, the natural frequency is determined in a frequency range of greater than 0.01 Hz, preferably greater than 0.1 Hz and in particular greater than 1 Hz.

Frequencies lower than this cannot be easily excited by the Dirac impulse and are of no interest for the measurement, as the typical frequencies of the machine are above the limit specified here.

Preferably, the natural frequency is determined in a frequency range of less than 1 kHz, preferably less than 500 Hz and in particular less than 50 Hz.

The Dirac pulse will excite higher frequencies only slightly, and the operating frequency will not be above this limit, so that natural frequencies above these values do not pose any danger to the machine.

Preferably, the operating frequency is changed after the frequency analysis step and all steps are repeated.

By changing the operating frequency, it can be ensured that no new natural frequencies occur at the different operating frequencies or that the existing natural frequencies are weighted differently. A user of a vibration machine wants to have certainty over a large number of possible operating frequencies and not have to check whether this is safe every time he wants to set a new operating frequency.

Preferably, an excitation vibration signal is transmitted to the vibration machine at several points.

This ensures that natural frequencies of the vibration machine are also detected that may have been overlooked at other points.

Preferably, a response vibration signal is measured at several points.

This ensures that all natural frequencies of the vibration machine are recorded in the predetermined range.

Preferably, the determination of an operating vibration signal, the excitation of the vibration machine and the measurement of a response vibration signal are superimposed in time and/or take place simultaneously. A response vibration signal is recorded, which comprises the operating vibration signal and the response to the excitation. The correction signal is generated from this response vibration signal and the correction signal is then subtracted from the response vibration signal so that the subtraction signal is obtained. The subtraction signal thus corresponds approximately to a response vibration signal for a machine that is not in operation. The subtraction signal is then subjected to frequency analysis to determine the natural frequencies of the vibration machine.

The use of a response vibration signal, which includes the operating vibration signal and the response to the excitation, simplifies the evaluation. The phases of the operating oscillation and its harmonics can be determined using an FFT. Since the individual phases of the harmonics of the operating vibration signal and the individual phases of the harmonics of the response vibration signal are based on the same measurement of the response vibration signal, they have the same relative reference. It is therefore not necessary to determine such a phase reference of the response vibration signal to the operating vibration signal afterwards, e.g. by means of a phase adjustment, an additional FFT determination or a phase determination by determining a time interval.

Although the individual steps can also be carried out one after the other, if they are superimposed in time and/or carried out simultaneously, the operating vibration signal and the response vibration signal can be recorded in a joint measurement.

Since the frequency of the operating oscillation clearly dominates, the impulse response does not influence the determination of the frequency.

A measuring system for measuring natural vibrations on a vibration machine, which is designed to carry out one of the methods described above, comprises at least one vibration detection device and an evaluation device.

Such vibration detection devices include, for example, the sensors described above, and an evaluation device can be a computer as described above.

A vibrating screen is a machine for sieving. A mixture of solids is separated according to the size of the grains.

A vibrating conveyor is a machine for transporting bulk material. The bulk material is moved by means of linear, circular or elliptical vibrations.

Machines are also known that include both features.

Vibrating conveyors comprise a conveying device, usually a vibrating conveyor trough, a vibration drive and an elastic suspension.

The components of the vibrating conveyor, with the exception of the suspension, should be resistant to deformation. This allows the vibration to be transmitted evenly along the vibrating conveyor trough. In addition, fatigue fractures are avoided for as long as possible.

### BRIEF DESCRIPTION OF THE FIGURES

The invention is explained in more detail below with reference to the examples shown in the drawings. The drawings show schematically:

FIG. 1A side view of a vibration machine with a vibration sensor and an evaluation device,

FIG. 2A frequency spectrum of a response vibration signal,

FIG. 3A response vibration signal and a correction signal superimposed on each other,

FIG. 4A response vibration signal and a subtraction signal,

FIG. 5A frequency spectrum of a conventional vibration analysis of a vibration machine when switched off,

FIG. 6A frequency spectrum of an oscillation analysis of the subtraction signal, and

FIG. 7A flow diagram of the procedure for resonance analysis of a vibration machine during operation.

### DETAILED DESCRIPTION

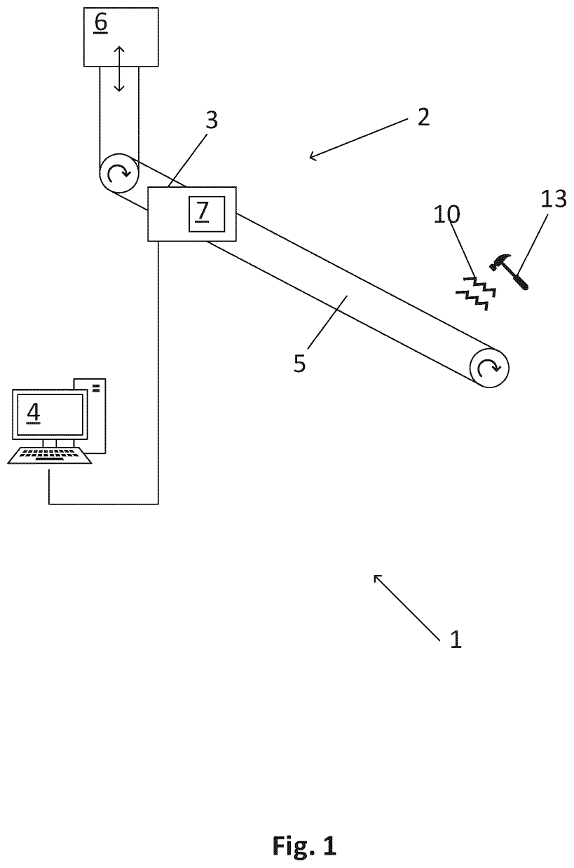

A system for resonance analysis of a vibration machine 1 comprises a vibrating conveyor 2, a vibration detection device 3 and an evaluation device 4 (FIG. 1).

The vibrating conveyor 2 is designed for conveying piece goods, e.g. castings, and bulk goods, e.g. sand or gravel

The vibrating conveyor 2 comprises a vibrating conveyor trough 5 and a vibratory drive 6.

The vibrating conveyor trough 5 is designed with a conveyor floor (not shown), which is arranged in a vibrating frame. The conveyor floor transports the bulk material. An oscillating drive 6 is connected to the oscillating frame and sets it in oscillating motion.

The oscillating drive 6 is aligned at a predetermined angle to the conveyor floor (not shown) and causes it to oscillate in a predetermined direction.

The oscillating drive 6 can be adjusted with regard to the oscillation frequency.

The vibrating conveyor trough 5 is arranged at a predetermined angle to the floor and to the vibratory drive 6.

The conveying behavior is influenced depending on the angle to the floor and the angle to the oscillating drive 6 as well as the frequency.

The oscillating drive 6 comprises an unbalance motor, which in this design example is a three-phase motor with an adjustable unbalance weight (not shown) at one end of the shaft. The amplitude of the generated vibration can be changed by manually adjusting the unbalance. The frequency is determined by the speed of the motor.

In this design example, two counter-rotating drives are used. A single motor would generate a circular motion and not a linear oscillation.

In an alternative embodiment, an oscillating armature drive can also be used.

The vibration detection device 3 has at least one vibration sensor 7. In this design example, the vibration sensor 7 is an acceleration sensor that measures vibrations of the vibrating conveyor 2 in all three spatial axes. The vibration sensor 7 is connected to the evaluation unit 4 via a wireless connection. In principle, wired connections are also possible.

The connection between the vibration detection device 3 and the evaluation device 4 can be made via radio, for example Bluetooth, WLAN, ZigBee, Z-Wave or via a mobile network, or can be cable-based, e.g. via a LAN network.

The vibration sensor 7 is connected to the vibrating conveyor 2 via an attachment device. This connection can be fixed (e.g. using screws) or detachable (e.g. using adhesive strips or a clamping mechanism).

The evaluation device 4 can be designed as a computer, conventional smartphone or tablet, which uses an additional software application, also known as an app, to process the data from the vibration sensor 7 recorded by a receiver module.

The evaluation device 4 can also include a display device that visually outputs the recorded and processed data.

The system for resonance analysis of a vibration machine 1 also comprises an impulse hammer 13, which is not shown here. In this embodiment example, the impulse hammer 13 has a force sensor that measures the transmitted impulse when striking the vibrating conveyor 2.

The procedure for resonance analysis of a vibration machine 2 during operation is explained below.

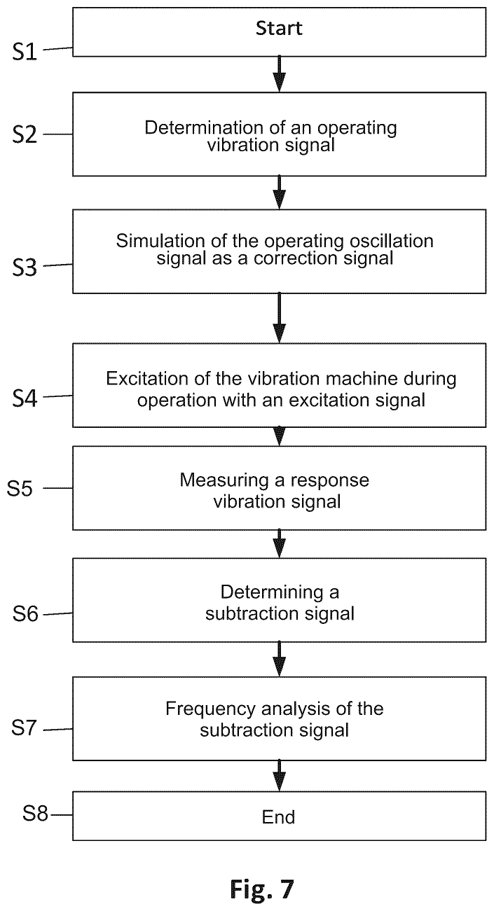

The process begins with step S1 (FIG. 7).

In the next step (S2), the operating vibration signal 8 is determined. For this purpose, the sensors of the vibration detection device 3 measure the movements of the vibration machine 2, whereby the movements are generated by the vibration generator 2. The data is then sent to the evaluation device 4.

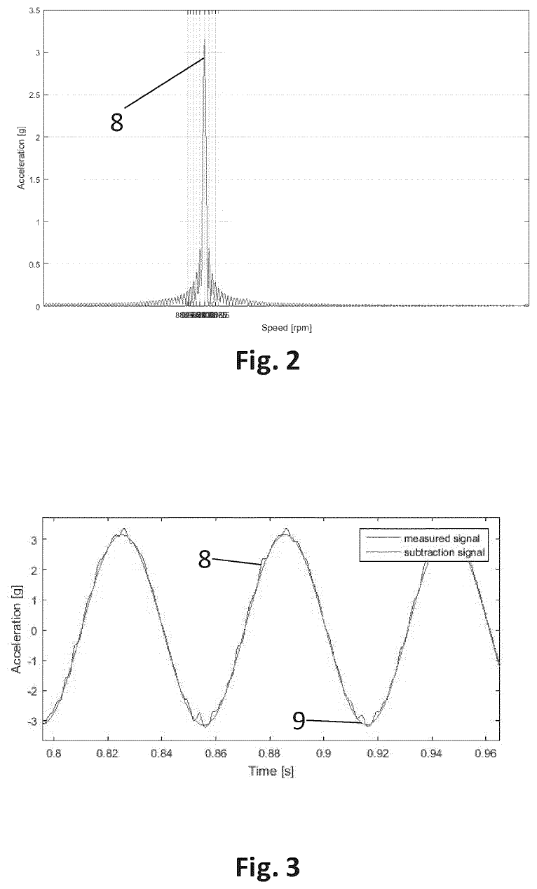

In the evaluation unit 4, the operating vibration signal 8 is transferred from the time domain to the frequency domain using a Fast Fourier transformation. FIG. 2 shows a single peak that corresponds to the operating frequency.

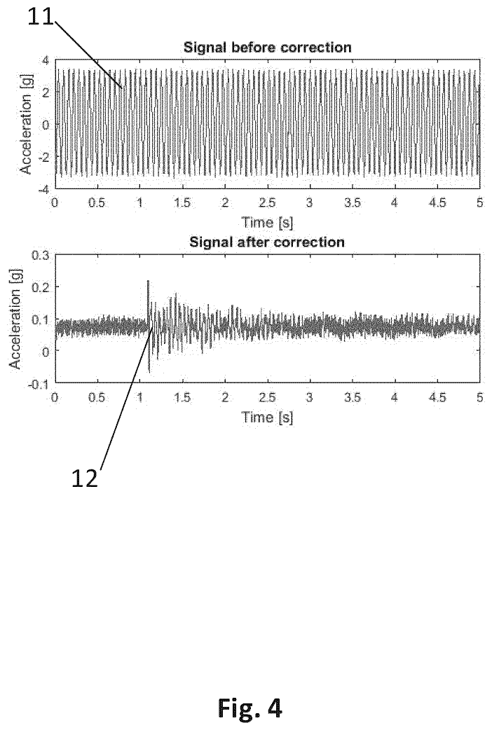

The amplitude and phase are determined over time. FIG. 3 shows a temporal section of the operating vibration signal 8, from which the amplitude and phase can be read.

The operating vibration signal 8 is then modified and used as a correction signal 9 (step S3) (FIGS. 3 and 4).

A specific duration of the operating vibration signal 8 is approximated into a mathematical function using an automatic parameter estimation (fit).

This mathematical function has the form:

$$y ( t ) = {\sum }_{n = 1}^{k} {A}_{n} sin ( nft + {P}_{n} ) ,$$

where n is the degree of the harmonic, k is the highest harmonic, Aₙ is the amplitude of the harmonic, f is the operating frequency, t is the time and Pₙ is the phase of the respective harmonic.

Alternatively, the operating vibration signal 8 can also be converted into the frequency domain using a Fast Fourier Transformation (FFT). The operating frequency can then be read in the frequency space, as it is the dominant signal here. The amplitude and phase of the operating vibration signal 8 is derived from the original operating vibration signal 8.

Once the operating frequency, amplitude and phase have been determined, the correction signal 9 can be calculated using these parameters and the parameters of the harmonics whose parameters were also determined by the fit.

If the operating vibration signal 8 has been fitted, the fit is used as the correction signal 9.

If the parameters were determined manually in the time and frequency range, the correction signal 9 also results from the mathematical function:

$$y ( t ) = {\sum }_{n = 1}^{k} {A}_{n} sin ( nft + {P}_{n} ) ,$$

where the parameters have the same meaning as described above and the respective specific parameters were used. FIG. 3 shows such a manual adjustment of the temporal signal. The modified operating vibration signal 8 is smoothed compared to the original measured operating vibration signal or correction signal 9. Such a “smooth” sinusoidal signal can be easily represented by a formula, which simplifies the further calculation.

Step S4 follows, in which the vibration machine 2 is excited with an excitation signal 10 during operation.

This is done using an impulse hammer 13, which is struck on the oscillating machine 2.

A visual or acoustic signal tells the user when to strike. The measurement is also started with the signal.

In the following step S5, a response vibration signal 11 is measured. The measurement procedure is similar to the measurement of the operating vibration signal 8 from step S2. Here too, the vibrations are measured via sensors in the vibration detection direction 3 and sent to the evaluation unit 4.

In this embodiment example, the measurement of the operating vibration signal 8 and the measurement of the response vibration signal 11 are carried out one after the other.

A subtraction signal 12 is then determined in step S6 by subtracting the correction signal 9 from the response vibration signal 11.

The response vibration signal 11 is selected in the evaluation unit 4 and the correction signal 9 is mathematically subtracted from it. As the measurement of the operating vibration signal 8 and the measurement of the response vibration signal 11 are carried out one after the other, the correct phase of the response vibration signal 11 must be ensured.

The correct phase is determined by adjusting a parameter that changes the phase until the generated subtraction signal 12 in the FFT space does not show the operating frequency or shows it only faintly.

As a result, only the reaction of the vibration machine 2 to the excitation signal 10 can be seen in the generated subtraction signal 12 (see FIG. 4).

In the subsequent step S7, the subtraction signal 12 is transferred to frequency space using a Fast Fourier Transformation. The peaks that can be recognized there correspond to the natural frequencies of the oscillating machine 2 (FIG. 6).

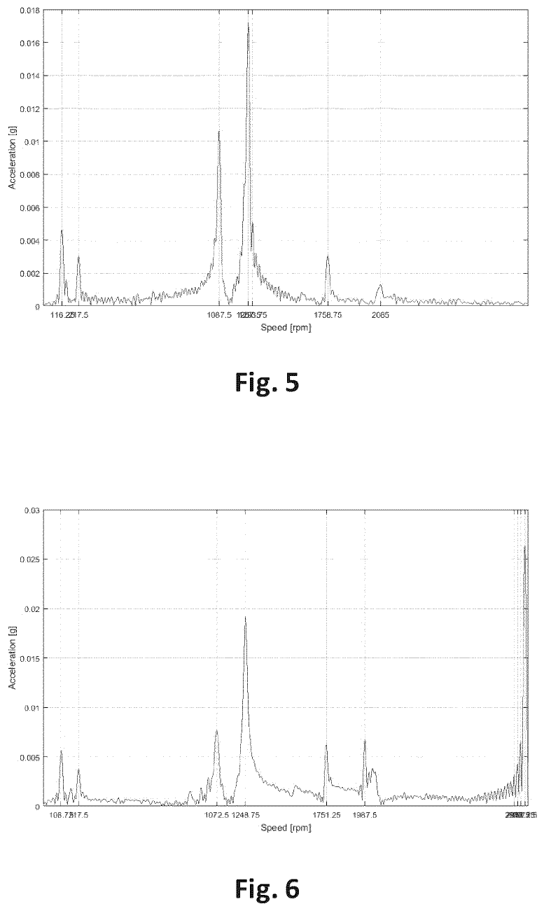

As FIG. 6 shows, the natural frequencies determined correspond almost exactly to the natural frequencies determined using a method in which the vibration machine is stopped without load (FIG. 5):

| | Measurement | Measurment | | |
|---|---|---|---|---|
| | according to | according to | | |
| | the prior art | the present | Difference | Difference |
| Resonance | [rpm] | method [rpm] | [rpm] | [%] |
| 1 | 1267.5 | 1248.75 | −18.75 | −1.48 |
| 2 | 1087.5 | 1072.5 | −15.00 | −1.38 |
| 3 | 1758.75 | 1751.25 | −7.50 | −0.43 |
| 4 | 2085 | 2043.75 | −41.25 | −2.00 |
| 5 | 116.25 | 108.75 | −7.50 | −6.45 |
| 6 | 217.5 | 217.5 | 0 | 0 |
| 7 | — | 1987.5 | — | — |
| 8 | — | 2977.5 | — | — |

A deviation of between 0.4 and 6.4% can be observed. What is striking here is that the deviation is always in the same direction, which suggests that the deviations are systematic deviations caused by the operation of the machine. Another reason could be the loading of the machine.

Peaks 5 and 6 are each resonances of the rigid body; a particularly high deviation can also be seen here.

Peaks 7 and 8 are artifacts and correspond to the first two harmonics.

The method ends with step S8.

Another possibility is that once a correction signal 9 has been generated, any signal that is measured is corrected with the correction signal 9.

This results in a zero line without an excitation signal 10 and this can be recognized immediately when an excitation signal 10 is applied.

In an alternative embodiment, an impulse hammer 13 is not used. The excitation signal 10 is generated automatically by larger chunks of material that fall onto the vibration machine 2. This enables long-term and repeated monitoring of the natural frequencies during operation.

In a further alternative embodiment, the measurement of the response vibration signal 10 is triggered by the hammer stroke.

As described above, if the operating vibration signal 8 and the response vibration signal 11 are not measured simultaneously, the phase of the operating oscillation in the response vibration signal 11 and its harmonics must be known in order to subtract the correction signal 9 with the correct phase from this response vibration signal 11 in order to obtain the subtraction signal 12.

In addition to the above-mentioned possibility of adjusting the phase of the response vibration signal 11 until the signal of the operating oscillation is minimized, alternatives are listed below as to how the phases of the operating vibration signal 8 and the response vibration signal 11 can be brought into agreement.

In a first alternative embodiment, the phase of the correction signal 9 is determined by a phase spectrum. This phase spectrum is generated by the FFT as explained in the alternative form of step S3 above.

The phases of the response vibration signal 11 are then also determined using an FFT.

The phase of the operating oscillation in the response vibration signal 11 is determined as the preferred phase at the corresponding frequency.

The phases of the harmonics are determined again by the FFT of the response vibration signal 11. Alternatively, when determining the phases of the harmonics in the operating vibration signal 8, the relative reference to the phase of the operating oscillation is measured as relative phases. This relative reference is also retained in the response vibration signal 11. If the phase of the operating oscillation in the response vibration signal 11 is known as the preferred phase, the absolute phases of the harmonics are determined by addition from the preferred phase and the relative phases.

For example, if the relative phase of the 1st harmonic is 90° and the preferred phase is 45°, the absolute phase of the 1st harmonic results from the addition of 90° and 45° to 135°.

Alternatively, the phase can be determined by the time duration between the measurement of the operating vibration signal 8 and the measurement of the response vibration signal 11. If the duration is known exactly, as well as the phases of the operating vibration signal 8 at the end of the measurement, the phase at the beginning of the measurement of the response vibration signal 11 is determined by the respective frequency and the duration.

If, for example, the duration is 60 seconds, the frequency of the operating oscillation is 30 Hz and the operating oscillation ends in the operating vibration signal 8 with a phase of 45°, this results in an initial phase PAA in the response vibration signal 11:

$${P}_{AA} = ( 30 s * ( 30 Hz ) ) ° + 45 ° = 1800 ° + 45 ° = 0 ° + 45 ° = 45 °$$

In the simplest case, the measurements are carried out directly one after the other. The duration between the measurements is then zero. The phases at the beginning of the measurement of the response vibration signal 11 are equal to the phases of the operating vibration signal 8 at the end of the measurement.

The measurement of the operating vibration signal 8 and the response vibration signal 11 can also be carried out as a continuous measurement, which is then divided manually or automatically by the evaluation device 4. In this case, the duration between the partial measurements is also zero.

A further embodiment example is described below, whereby identical elements as in the first embodiment example are provided with the same reference signs. The explanations given above apply to identical elements, unless otherwise stated below.

This embodiment example differs from the first embodiment example in that the determination of an operating vibration signal 8, the excitation of the vibration machine 2 and the measurement of a response vibration signal 11 take place simultaneously.

Only one signal is measured here, which comprises the response vibration signal 11. It is measured while the excitation signal 10 excites the oscillating machine 2.

The operating vibration signal 8 will dominate the measurement. If the measured signal is Fourier-transformed by an FFT, the frequency of the operating oscillation will be recognized as the strongest signal. The harmonics can then be determined by the multiples of this frequency, whereby, as mentioned above, subharmonics with e.g. half the frequency are also included.

The frequencies that were excited by the excitation signal 10 are also contained in this FFT, but are superimposed by the operating oscillation and its harmonics.

During the Fourier transformation, the amplitudes and phases of the operating oscillation and its harmonics are also determined.

The correction signal 9 is formed from this information, the frequencies, amplitudes and phases, as explained in step S3 in the above example.

The subtraction signal is then generated in the same way as in step S6.

The advantage here is that only one measurement is used. On the one hand, this simplifies the measurement. Furthermore, it is no longer necessary to ensure that the phase of the response vibration signal 11 is the same as the operating vibration signal 8. By using a common measurement, the phase is automatically identical.

The methods described here therefore not only allow a resonance measurement to be carried out during operation, but the measurement carried out is also more accurate as it more closely reflects reality. Thus, a systematic deviation of the method described here compared to the conventional method in switched-off operation without load is recognizable. However, since the vibration machine is in operation with a load for a large part of the time, it is very advantageous to know the natural frequencies in operation with a load and not those in operation without a load. In this way, a resonance catastrophe can be efficiently prevented.

The vibration machine 2 can also be designed as a vibrating screen 2 instead of a vibrating conveyor 2. The different screen layers can also lead to a change in the loading condition during operation. This can have an effect on the natural frequencies, even if these are usually undesirable. Changes can also be caused by the bulk material properties of the plant process changing.

All changes to the bulk material behavior will again have an effect on the resonance behavior.

### REFERENCE SIGNS

1 System for resonance analysis of a vibration machine
2 Vibration machine
3 Vibration detection device
4 Evaluation device
5 Vibrating conveyor trough
6 Vibratory drive
7 Vibration sensor
8 Operating vibration signal
9 Correction signal
10 Excitation signal
11 Response vibration signal
12 Subtraction signal
13 Pulse hammer

1-15. (canceled)

16. A method for resonance analysis of a vibration machine, namely a vibrating screen or a vibrating conveyor, during operation, comprising the following steps:
determination of an operating vibration signal comprising the vibrations of the vibration machine in regular operation,
excitation of the vibration machine during operation with an excitation signal for exciting additional vibrations at the vibration machine, wherein the excitation signal is a Dirac pulse,
measuring a response vibration signal of the vibration machine to the excitation during operation,
determining a correction signal by using the operating vibration signal,
determining a subtraction signal by subtracting the correction signal from the response vibration signal, and
frequency analysis of the subtraction signal for determining the natural frequencies of the vibration machine, wherein the dominant frequencies of the subtraction signal correspond to the natural frequencies of the system in the frequency range of the excitation signal.

17. The method according to claim 16, wherein the operating vibration signal is modified before it is used as a correction signal.

18. The method according to claim 17, wherein when generating the correction signal:
the frequency with the highest amplitude is determined from the operating vibration signal, hereinafter referred to as the operating frequency,
the amplitude and phase of the operating frequency are determined in the operating vibration signal,
the amplitude and phase of the harmonics of the operating frequency in the operating vibration signal is determined,
the correction signal is generated from the amplitude and phase of the operating frequency and from the amplitude and phase of the harmonics of the operating frequency.

19. The method according to claim 18, wherein the harmonics are one or more of the multiples of the operating frequency, preferably ½, 3/2, ⅓, ⅔, 2, 3, 4, 5, 8, 16, and 32 times the operating frequency.

20. The method according to claim 17, wherein the operating vibration signal is estimated by automatic parameter estimation and modified using the resulting parameters.

21. The method according to claim 16, wherein the correction signal is modeled on the operating vibration signal by taking up the operating vibration signal over a predetermined duration and using it as the correction signal.

22. The method according to claim 16, wherein the operating vibration signal is used as a correction signal.

23. The method according to claim 16, wherein the natural frequencies are determined in a frequency range of greater than 0.01 Hz, preferably of greater than 0.1 Hz and in particular of greater than 1 Hz.

24. The method according to claim 16, wherein the natural frequencies are determined in a frequency range of up to less than 1 kHz, preferably up to less than 500 Hz and in particular up to less than 50 Hz.

25. The method according to claim 16, wherein after the step of frequency analysis, the operating frequency is changed and all steps are repeated.

26. The method according to claim 16, wherein an excitation vibration signal is transmitted to the vibration machine at several points.

27. The method according to claim 16, wherein a response vibration signal is measured at several of points.

28. The method according to claim 16, wherein the determination of an operating vibration signal, the excitation of the vibration machine and the measurement of a response vibration signal are superimposed in time and/or take place simultaneously.
